(19) United States
(12) Patent Application Publication
(10) Pub. No.: US 2010/0310260 A1
(43) Pub. Date: Dec. 9, 2010

(54) Optical Receiver

(75) Inventor: Kohei MANDAI, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Opnext Japan, Inc., Yokohama-shi (JP)

(21) Appl. No.: 12/795,264

(22) Filed: Jun. 7, 2010

(30) Foreign Application Priority Data
Jun. 8, 2009 (JP) 2009-137113

(51) Int. Cl. H04B 10/06

(52) U.S. Cl. 398/202

(57) ABSTRACT

The interference phases of two optical delay line interferometers of an optical receiver adopting the DQPSK or the like are stabilized at points, which have a difference of 90°, without bifurcation of a receiving signal or receiving data. A low-speed photocurrent flowing through the current source terminal of a photodetector that receives interfering light outputted from an optical delay line interferometer is detected. The interference phase is identified by utilizing a variation in the AC or DC component of the photocurrent dependent on the interference phase of the optical delay line interferometer. The difference between the interference phases of two optical delay line interferometers is controlled to be 90°.

### CLAIM OF PRIORITY

The present application claims priority from Japanese patent application JP 2009-137113 filed on Jun. 8, 2009, the content of which is hereby incorporated by reference into this application.

### BACKGROUND OF THE INVENTION

1. Field of the Invention

The present invention relates to an optical receiver, or especially, to an optical receiver that is included in an optical communication system and receives a light signal that is phase-modulated according to the differential quadrature phase-shift keying (DQPSK). More particularly, the present invention is concerned with an optical receiver in which the operating points of two optical interferometers that convert phase-modulated signal light into intensity-modulated signal light are stabilized.

2. Description of the Related Art

As a transmission code for increasing a light-signal transmission capacity, a phase modulation scheme based on the differential quadrature phase shift keying (DQPSK) is attracting attention. From the viewpoint of high sensitivity, the return-to-zero (RZ) DQPSK for modulating the intensity of DQPSK-modulated signal light in a pulsating manner is often employed.

In order to receive data transmitted according to the transmission code, a DQPSK optical receiver is needed. FIG. 1 shows an example of the configuration of the DQPSK optical receiver. Signal light inputted to an input port 100 of the DQPSK optical receiver 101 is bifurcated by an optical splitter 110, and inputted to optical phase detectors 120 and 120b having the same configuration. The signal light inputted to the optical phase detector 120 is inputted to an optical delay line interferometer 130. The optical delay line interferometer 130 bifurcates the signal light, transfers one of resultant light waves to an optical delay line 131, and transfers the other light wave to an optical phase shifter 132. Thus, the two bifurcated signal light waves are given an appropriate delay time difference and an appropriate phase difference, and interfered with each other. Interfering light waves having intensity patterns that are mutually logical inverses are outputted through different ports. Normally, a delay quantity to be given by the optical delay line 131 is an integral multiple of a modulation cycle for inputted signal light. The optical phase shifter 132 has the phase shift quantity thereof appropriately controlled by a phase controller 133. The phase shift quantity shall be called an interference phase to be given by the optical delay line interferometer 130. The two interfering light waves outputted from the optical delay line interferometer 130 are inputted to an optical balanced receiver 140. In the optical balanced receiver 140, two photodetectors 141 and 142 receive the two interfering light waves, and convert them into detection signals 143 and 144 that are electric signals whose amplitudes are proportional to the intensity components of the interfering light waves. Further, a difference circuit 145 calculates the difference between the detection signals 143 and 144, and outputs the difference as a receiving signal 146. Incidentally, one of the two detection signals 143 and 144 may be outputted as the receiving signal 146. In this case, although receiving sensitivity is halved, one of the two photodetectors 141 and 142 of the optical balanced receiver 140 and the difference circuit 145 can be excluded. Thus, the phase component of signal light inputted to the input port 100 is converted into an electric signal. The receiving signal 146 is discriminated by a discriminator 150, and outputted as receiving data 151 from the optical phase detector 120. The optical phase detector 120b converts, similarly to the optical phase detector 120, signal light inputted to the input port 100 into an electric signal that is receiving data 151b.

As mentioned above, the phase shift quantity to be given by the optical phase shifter 132 is called the interference phase to be given by the optical delay line interferometer 130. The pattern of the receiving data 151 varies depending on the interference phase. FIG. 2 is a relationship diagram for the interference phase and receiving data pattern in a case where signal light inputted to the input port 100 is a DQPSK signal. An output pattern is manifested in the receiving data at interference phases of 45°, 135°, 225°, and 315°. The output pattern varies among patterns A, B, Ā, and B̅. Herein, the patterns A and Ā and the patterns B and B̅ are mutually logically inverted patterns. A transmitting side transmits the pattern A and pattern B. The DQPSK optical receiver 101 has to receive the pattern A (or Ā) and pattern B (or B̅). The interference phases of the optical delay line interferometers 130 and 130b of the optical phase detectors 120 and 120b respectively are 90° changed from each other, so that the pattern A (or Ā) and pattern B (or B̅) can be received. In the DQPSK optical receiver, thus obtained receiving data items 151 and 151b are joined at the same timing in order to demodulate transmission data, though it is not shown in FIG. 1.

As mentioned above, in the DQPSK optical receiver, the interference phases of the two optical delay line interferometers 130 and 130b have to be controlled to be appropriate values. Patent document 1 (JP-A-2007-181171) reads a method for controlling the interference phase of an optical delay line interferometer. According to the method, the fact that the amplitude of the receiving signal 146 varies depending on the interference phase of the optical delay line interferometer 130 is utilized in order to control the interference phase so that the amplitude of the receiving signal 146 can be minimized. Thus, the interference phase is stabilized at any of 45°, 135°, 225°, and 315°. In this specification, control to be implemented in order to obtain the interference phase shall be called “45° phase control.” In addition, if the interference phase is controlled so that the amplitude of the receiving signal 146 can be maximized, the interference phase can be stabilized at any of 0°, 90°, 180°, and 270°. In this specification, control to be implemented in order to obtain the interference phase shall be called “90° phase control.” However, adoption of the method alone cannot guarantee that the difference between the interference phases of the optical delay line interferometers 130 and 130b becomes 90°.

A method for stabilizing the difference between the interference phases of the two optical delay line interferometers 130 and 131b at 90° is further needed. In the present specification, a control method for obtaining the interference phase shall be called a “quadrature phase control method.”

Patent document 2 (JP-A-2006-270909) reads an example of the method. In this example, an exclusive OR of receiving data items 151 and 151b is obtained in order to detect a degree of correlation. If the two receiving data items 151 and 151b correlate with each other, the two optical phase detectors 120 and 120b output the receiving data items 151 and 151b that are identical to each other or are mutually logical inverses. The difference between the interference phases of the optical delay line interferometers 130 and 130b is not 90°. One of the interference phases of the two optical delay line interferometers 130 and 130b is shifted 90°. In contrast, if the two receiving data items 151 and 151b do not correlate with each other, the difference between the interference phases of the optical delay line interferometers 130 and 131b is 90°.

Patent document 3 (JP-A-2008-147861) reads a method for simultaneously implementing 45° phase control and quadrature phase control. According to the method, the receiving signal 146 and receiving data 151b that are not discriminated are multiplied by each other in order to detect a temporal mean. The interference phase of the optical delay line interferometer 130 is controlled so that the detection signal becomes null.

### SUMMARY OF THE INVENTION

However, according to the existing methods, a high-speed correlator is needed to correlate a receiving signal, which is modulated at a high speed, or receiving data. In addition, the receiving signal or receiving data has to be bifurcated and fetched into the correlator. If a bifurcation circuit causes a delay difference, the receiving signal or receiving data deteriorates. For example, in the case of a DQPSK optical receiver that receives DQPSK signal light at 43 Gbps, if the bifurcation circuit that provides two receiving data items has a path difference of several millimeters, the two receiving data items may not be able to be correctly joined in a stage succeeding the bifurcation circuit. When the receiving signal is bifurcated and used for control as it is in the patent document 3, if impedance matching is not achieved relative to the bifurcation circuit, signal reflection occurs. Eventually, the receiving signal deteriorates. Thus, it is hard to design the bifurcation circuit.

Accordingly, an object of the present invention is to provide an optical receiver that does not bifurcate a receiving signal or receiving data but stabilizes the interference phases of two optical delay line interferometers, which are included in an optical receiver adopting the DQPSK or the like, at points that have a difference of 90°.

Another object of the present invention is to detect a difference between the interference phases of two optical delay line interferometers, which are included in a DQPSK optical receiver, without an adverse effect on a receiving signal or receiving data and without use of a high-speed circuit. Still another object of the present invention is to control the interference phases of the two optical delay line interferometers, which are included in the DQPSK optical receiver, so that the interference phases take on optimal values having a difference of 90°.

According to the present invention, one of the features of a DQPSK optical receiver is such that photocurrents flowing through current source terminals of photodetectors that receive interfering light waves outputted from two optical delay line interferometers are detected, and the photocurrents are used to control the difference between the interference phases of the two optical delay line interferometers so that the difference becomes 90°.

In order to prevent a disturbance from being applied to the photodetector through the current source terminal, the passband of the current source terminal is incomparably smaller than the frequency band handled by the photodetector. The frequency band of a photocurrent flowing through the current source terminal is very small. FIG. 3A shows a photocurrent, which flows through the current source terminal 161 and varies depending on the interference phase of the optical delay line interferometer 130 in a case where the DQPSK optical receiver 101 has received RZ-DQPSK signal light, and a temporal waveform of a detection signal 143. The photocurrent is a wave having the high-frequency component of the detection signal 143 removed, and the AC component of the photocurrent is smaller than that of the detection signal 143. FIG. 3B shows the temporal waveform of the AC component of the photocurrent that varies depending on the interference phase of the optical delay line interferometer 130. The waveforms dependent on interference phases having a difference of 90° do not correlate with each other, and the waveforms dependent on interference phases having a difference of 180° are mutually inverted. Incidentally, a known method of removing a DC component from an input signal can be employed in a DC component remover that detects the AC component of the photocurrent 161. For example, a capacitor or a signal processor that calculates a temporal mean value from an input signal and subtracting the temporal mean value from the input signal is adopted as the DC component remover. The photocurrent flowing through the current source terminal 161 is inputted to the DC component remover.

According to one aspect of the present invention, the AC component of a photocurrent is employed. More particularly, the waveforms of AC components of photocurrents flowing through the current source terminals of the photodetectors of the two optical phase detectors 120 and 120b of the DQPSK optical receiver 101 are observed to see if they correlate with each other. If the waveforms correlate with each other, the interference phase of the optical delay line interferometer in one or both of the optical phase detectors 120 and 120b is shifted so that the difference between the interference phases of the two optical delay line interferometers becomes 90°. As a method for 90° shifting the interference phase, there are several methods including known methods, for example, a method of gradually shifting the interference phase until the AC components of the two photocurrents do not correlate with each other any longer, a method of performing 45° phase control or any other optimization control on the interference phase after shifting the interference phase approximately 90°, and a method of controlling the interference phase by referencing the relationship between a control signal for the interference phase, which is produced in advance, and the interference phase. Any of the methods may be adopted.

When a light signal having a non-modulated component is inputted to the input port 100 of the DQPSK optical receiver 101, the output power ratio relevant to the two output ports of the optical delay line interferometer varies depending on the interference phase. As a result, the amplitudes of DC components of photocurrents produced by the photodetectors vary depending on the interference phase. FIG. 6 shows the relationship between the interference phase of the optical delay line interferometer and the amplitudes of the photocurrents in a case where NRZ-DQPSK signal light is inputted to the input port 100.

According to another aspect of the present invention, the relationship between an interference phase and amplitudes of photocurrents is used to identify the interference phase. For example, in a DQPSK optical receiver having undergone 45° phase control, whether an interference phase is 45±n·180° or 135±n·180° can be decided using the amplitude of a photocurrent and a sign assigned to an increase or decrease in the photocurrent derived from a variation in the interference phase. In a DQPSK optical receiver having undergone 90° phase control, whether an interference phase is 0±n·180° or 90±n·180° can be decided by checking if the amplitudes of photocurrents of the two photodetectors, which receive the two outputs of the optical delay line interferometer, are squared with each other.

According to the present invention, there are provided two optical delay line interferometers, photodetectors that receive the output light waves of the optical delay line interferometers and output receiving signals, photocurrent detectors that detect photocurrents flowing through the current source terminals of the photodetectors, two phase controllers that control the interference phases of the optical delay line interferometers so that the interference phases are set to any of plural predetermined values, and a quadrature phase controller that identifies the difference between the interference phases of the two optical delay line interferometers on the basis of the photocurrents detected by the photocurrent detectors, and controls the phase control timing so that the difference becomes 90°.

According to the first solving means of this invention, there is provided an optical receiver comprising:

two optical phase detectors each including
an optical delay line interferometer that gives a delay difference and a phase difference, which corresponds to an interference phase to be designated, to bifurcated input signal light so as to cause interference, and outputs interfering light,
a photodetector that receives the interfering light and outputs a detection signal, and
a phase controller that stabilizes the interference phase of the optical delay line interferometer at any of a plurality of predetermined values;

at least one photocurrent detector that detects photocurrents, which flow through current source terminals of the photodetectors of the two optical phase detectors respectively, and outputs photocurrent signals in accordance with the photocurrents;

a correlator that inputs the photocurrent signals of the photodetectors, which are outputted from the photocurrent detector, or signals based on the photocurrent signals, and outputs a correlation signal in accordance with a correlation between AC components of the photocurrent signals; and

a quadrature phase controller that decides based on the correlation signal whether the difference between the interference phases of the two optical delay line interferometers is 90°, and that if the difference is not 90°, outputs a control signal to one or both of the phase controllers of the two optical phase detectors, wherein

one or both of the phase controllers of the two optical phase detectors shift the interference phases of the optical delay line interferometers according to the control signal.

According to the second solving means of this invention, there is provided an optical receiver comprising:

two optical phase detectors each including
an optical delay line interferometer that gives a delay difference and a phase difference, which corresponds to an interference phase to be designated, to bifurcated input signal light so as to cause interference, and outputs interfering light waves,
photodetectors that receive the interfering light waves and output detection signals, and
a phase controller that stabilizes the interference phase of the optical delay line interferometer at one of a plurality of predetermined values, microscopically fluctuates the interference phase, outputs a dither signal representing a fluctuation component, and shifts the interference phase according to an inputted control signal;

a first photocurrent detector which detects a first photocurrent, which flows through current source terminal of one of the photodetectors of the two optical phase detectors, and outputs a first photocurrent signal in accordance with the first photocurrent;

a second photocurrent detector which detects a second photocurrent, which flows through current source terminal of the other photodetector of the two optical phase detectors, and outputs a second photocurrent signal in accordance with the second photocurrent;

an amplitude comparator which compares amplitude of the first photocurrent signal with amplitude of the second photocurrent signal, and outputs an amplitude comparison signal signifying whichever of the first and second photocurrent signals is larger;

a synchronism detector which compares an increase or decrease in the dither signal outputted from the phase controller with an increase or decrease in the first or second photocurrent signal, and outputs gradient information on the first or second photocurrent signal; and

a quadrature phase controller which identifies the interference phase of the optical delay line interferometer on the basis of the gradient information and the amplitude comparison signal, and outputs a control signal to the phase controller so that the interference phase takes on a desired value.

According to the third solving means of this invention, there is provided an optical receiver comprising:

two optical phase detectors each including
an optical delay line interferometer that gives a delay difference and a phase difference, which corresponds to an interference phase to be designated, to bifurcated input signal light so as to cause interference, and outputs two interfering light waves whose intensity components are logically inverted each other,
two photodetectors that receive individual two interfering light waves, and
a phase controller that controls the interference phase of the optical delay line interferometer so that the interference phase becomes any of 0°, 90°, 180°, and 270°;

at least one photocurrent detector that detects photocurrents, which flow through current source terminals of the two photodetectors included in at least either of the two optical phase detectors, and outputs photocurrent signals in accordance with the photocurrents,

an amplitude comparator that compares DC components of the photocurrent signals with each other, and outputs an amplitude comparison signal in accordance with the difference between the DC components; and

a quadrature phase controller that identifies value of the interference phase of the optical delay line interferometer according to whether the amplitude comparison signal is null or equal to or smaller than a predetermined threshold, and outputs a control signal so as to set the difference between the interference phases to 90°, to the phase controller according to a result of identification.

According to the present invention, it is possible to provide an optical receiver that does not bifurcate a receiving signal or receiving data but stabilizes the interference phases of two optical delay line interferometers, which are included in an optical receiver adopting the DQPSK or the like, at points that have a difference of 90°.

According to the present invention, it is possible to detect a difference between the interference phases of two optical delay line interferometers, which are included in a DQPSK optical receiver, without an adverse effect on a receiving signal or receiving data and without use of a high-speed circuit. According to the present invention, it is possible to control the interference phases of the two optical delay line interferometers, which are included in the DQPSK optical receiver, so that the interference phases take on optimal values having a difference of 90°.

### BRIEF DESCRIPTION OF THE DRAWINGS

FIG. 1 shows an example of the configuration of a DQPSK optical receiver that is a subject of the present invention;

FIG. 2 is an explanatory diagram showing the relationship between an interference phase of an optical delay line interferometer and a receiving data pattern;

FIGS. 3A and 3B are explanatory diagrams showing a detection signal, which varies depending on an interference phase, and the temporal waveform of a photocurrent;

FIGS. 4A and 4B are explanatory diagrams concerning the operation of a correlator employed in the first embodiment of the present invention;

FIG. 5 shows an example of the configuration of the first embodiment of the present invention;

FIG. 6 is an explanatory diagram showing the relationship between the interference phase of the optical delay line interferometer and the amplitude of a DC component of a photocurrent;

FIG. 7 shows an example (1) of the configuration of the second embodiment of the present invention;

FIG. 8 shows an example (2) of the configuration of the second embodiment of the present invention;

FIG. 9 shows an example (3) of the configuration of the second embodiment of the present invention;

FIG. 10 shows an example of the configuration of the third embodiment of the present invention; and

FIG. 11 is an example of a flowchart describing interference phase control in the third embodiment.

### DESCRIPTION OF THE PREFERRED EMBODIMENTS

### First Embodiment

The first embodiment of the present invention utilizes an AC component of a photocurrent.

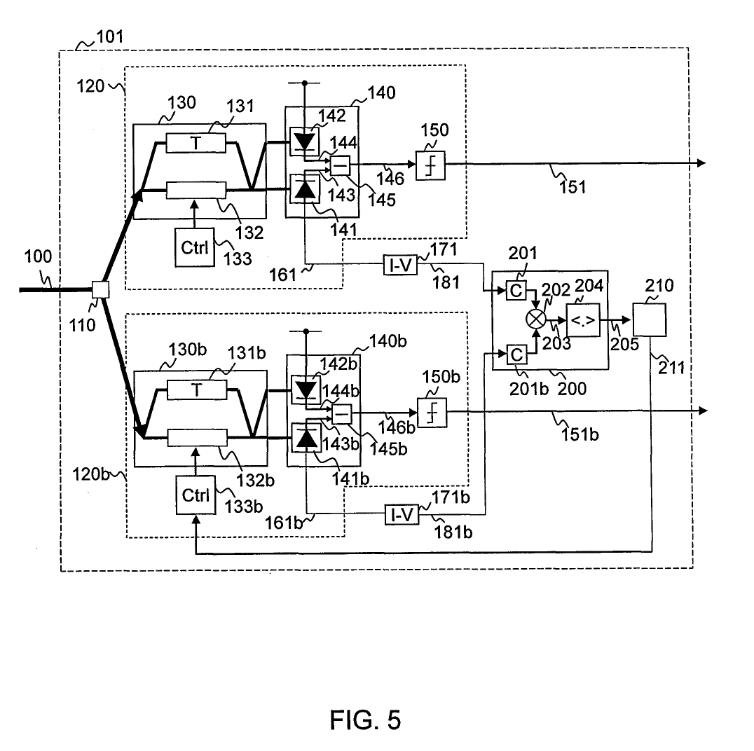

FIG. 5 is a configuration diagram of a DQPSK optical receiver.

A DQPSK optical receiver 101 includes, for example, optical phase detectors 120 and 120b, an optical splitter 110, photocurrent detectors 171 and 171b, a correlator 200, and a quadrature phase controller 210.

Photocurrents flowing through current source terminals 161 and 161b of two photodetectors 141 and 141b that receive interfering light waves outputted from two optical delay line interferometers 130 and 130b respectively are detected. DC current removers 201 and 201b are used to obtain the AC components of the two photocurrents. Further, the AC components are correlated with each other in order to detect the difference between the interference phases given by the two optical delay line interferometers 130 and 130b respectively.

As the correlator 200 that detects the correlation between the AC components of the photocurrents flowing through the current source terminals 161 and 161b, and that outputs a correlation signal, a known device or method for detecting the correlation between input signals can be adopted. For example, a combination of a multiplier that multiplies two input signals by each other, and an averaging processor that calculates a temporal mean of the output of the multiplier, or a combination of a comparator that compares two input signals with each other and outputs a signal signifying whichever of the input signals is larger or smaller, and an averaging processor, which calculates a temporal mean of the output of the comparator, such as a difference circuit (including a differential amplifier) may be adopted as the correlator. The AC components of the photocurrents flowing through the two current source terminals 161 and 161b may be inputted to the correlator.

Assuming that the correlator 200 is realized with the combination of a multiplier 202 and an averaging processor 204, the principles of the operation of the correlator 200 will be described below. For brevity's sake, a description will be made of a case where RZ-DQPSK signal light is received on the assumption that the interference phases of the optical delay line interferometers 130 and 130b included in the DQPSK optical receiver 101 have undergone 45° phase control, and the interference phase of the optical delay line interferometer 130b is controlled to be 45°

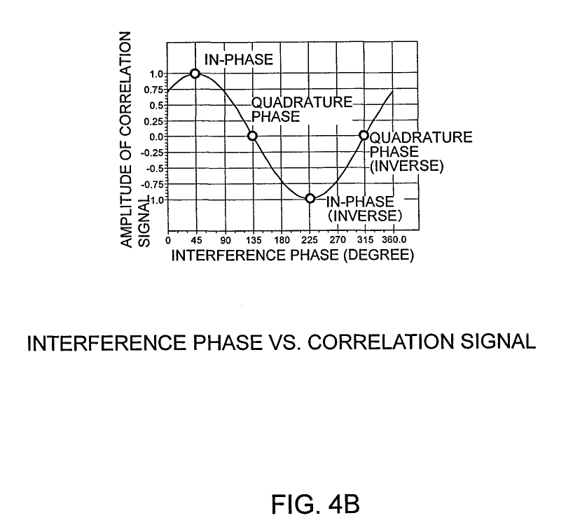

FIG. 4A shows how the output wave of the multiplier 202 included in the correlator 200 varies depending on the interference phase of the optical delay line interferometer 130. When the interference phase of the optical delay line interferometer 130 is 45°, the output wave of the multiplier 202 is larger than 0 all the time. In contrast, when the interference phase is 225°, the output wave is smaller than 0 all the time. When the interference phase is 135° or 315°, the sign of the output wave of the correlator varies at random, that is, changes from a positive sign to a negative sign or vice versa. Therefore, when the interference phase of the optical delay line interferometer 130 is set to 45°, 135°, 225°, or 315°, a correlation signal representing a temporal mean of the output of the multiplier, that is, a correlator output changes to a positive value, zero, a negative value, or zero.

FIG. 4B shows a variation in the correlation signal occurring in a case where the interference phase of the optical delay line interferometer 130 is successively changed. Assuming that the interference phase of the optical delay line interferometer 130b is stabilized at 30°, when the interference phase of the optical delay line interferometer 130 is 30°, the correlation signal becomes maximal. When the interference phase is 210°, the correlation signal becomes minimal. When the interference phase is 120° or 300°, the correlation signal becomes null. Namely, when the difference between the interference phases of the optical delay line interferometers 130 and 130b is 0°, the correlation signal takes on the positive maximum value. When the difference is 90°, the correlation signal takes on zero. When the difference is 180°, the correlation signal takes on the negative minimum value. Therefore, when the temporal mean of the correlation signal is set to zero, the difference between the interference phases of the two optical delay line interferometers 130 and 130b becomes 90°.

The present embodiment can be adapted to the DQPSK optical receiver 101 that receives signal light modulated according to a differential M-value phase modulation scheme (where M denotes an integer equal to or larger than 2) such as the differential 8 phase shift keying (D8PSK) or a quadrature amplitude modulation scheme such as the staggered-D8PSK or quadrature amplitude modulation (QAM). The difference between the interference phases of the two optical delay line interferometers 130 and 130b can be controlled to be 90°. For example, when QAM signal light is received using the DQPSK optical receiver 101 including two optical delay line interferometers 160 and 160b whose interference phases are subjected to 90° phase control and stabilized at any of 0°, 90°, 180°, and 270°, the difference between the interference phases of the two optical delay line interferometers 160 and 160b can be controlled to be 90° according to the first embodiment.

FIG. 5 shows the configuration of a DQPSK optical receiver 101 in accordance with the first embodiment of the present invention.

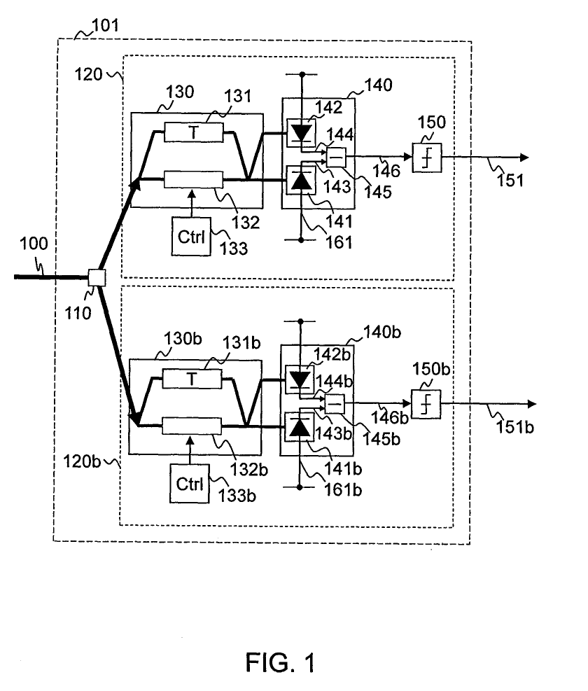

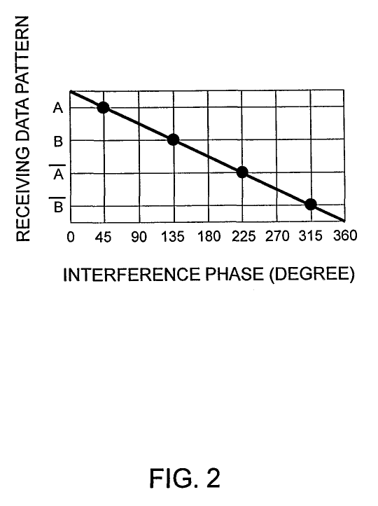

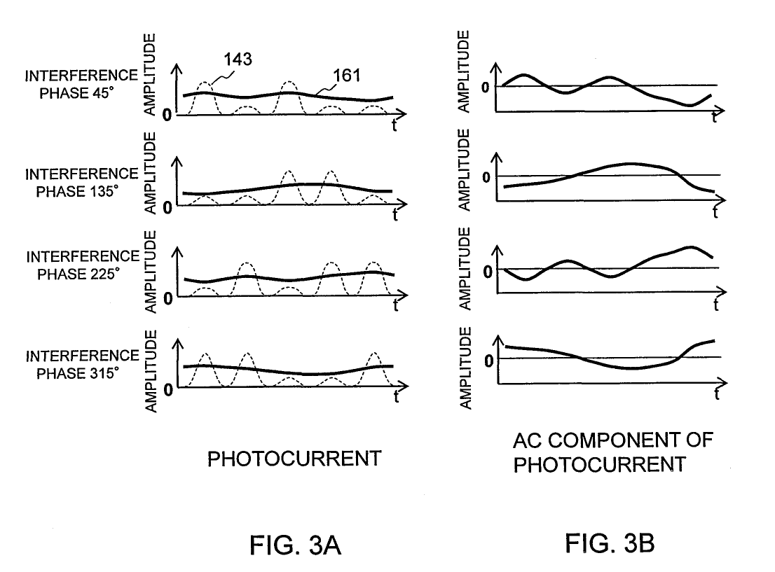

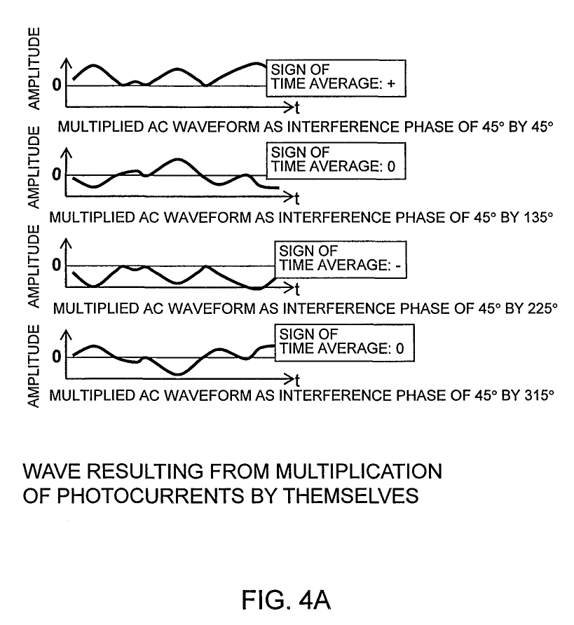

Similarly to the DQPSK optical receiver 101 shown in FIG. 1, signal light inputted to an input port 100 is converted into receiving data items 151 and 151b by two optical phase detectors 120 and 120b each of which includes an optical delay line interferometer and an optical balanced receiver. Each of photocurrent detectors 171 and 171b detects a photocurrent flowing through one of the current source terminals of two photodetectors 141 and 142 included in the optical balanced receiver 140 of the optical phase detector 120. For example, the photocurrent detector 171 converts a photocurrent, which flows through the current source terminal 161 of the photodetector 141, into a photocurrent signal 181, and outputs the photocurrent signal 181. As the photocurrent detectors 171 and 171b, a known means such as a current-to-voltage converter using an operational amplifier can be adopted. Likewise, a photocurrent flowing through the current source terminal of one of two photodetectors 141b and 142b included in the optical balanced receiver 140b of the optical phase detector 120b is detected. For example, the photocurrent detector 171b converts the photocurrent, which flows through the current source terminal 161b of the photodetector 141b, into a photocurrent signal 181b, and outputs the photocurrent signal 181b. The photocurrent signals 181 and 181b are inputted to a correlator 200.

In the correlator 200, DC component removers 201 and 201b extract the AC components of the photocurrent signals 181 and 181b respectively. In addition, a multiplier 202 multiplies the AC components of the photocurrent signals 181 and 181b by each other so as to calculate a multiplication signal 203. An averaging processor 204 calculates the temporal mean of the multiplication signal 203 and outputs the temporal mean as a correlation signal 205. Herein, the DC component removers 201 and 201b of the correlator 200 may be realized with capacitors or signal processors that calculate the temporal mean value from an input signal and subtracts the mean value from the input signal. The correlation signal 205 is inputted to a quadrature phase controller 210.

The quadrature phase controller 210 outputs a quadrature phase control signal 211 to one or both of phase controllers 133 and 133b until the correlation signal 205 becomes null (or falls within a predetermined range near zero). Each of the phase controllers 133 and 133b changes the phase-shift quantity to be given by each of optical phase shifters 132 and 132b during a period during which the phase controller is inputting the quadrature phase control signal 211.

If the phase-shift quantity to be changed with the quadrature phase control signal 211 is changed in units of 90°, it would prove efficient. However, after the phase-shift quantities of the phase shifters 132 and 132b are changed by 90° using the quadrature phase control signal 211, the time that elapses until the quadrature phase controller 210 discriminates the correlation signal 205 and outputs the quadrature phase control signal 211 has to be longer than response speeds at which the phase shifters 132 and 132b respond to the phase controllers 133 and 133b respectively.

The configuration of the correlator 200 may be any one as long as the correlation signal 205 to be outputted is a signal that varies depending on the difference between the interference phases of the two optical delay line interferometers 130 and 130b. For example, the correlator 200 may include a difference circuit that calculates the difference between the photocurrent signals 181 and 181b, a DC component remover that removes the DC component of the difference between the photocurrent signals 181 and 181b and outputs the resultant signal, and an amplitude detector that outputs the maximum amplitude of the output signal of the DC component remover as the correlation signal 205. In the case of this configuration, when the interference phases of the two optical delay line interferometers 130 and 130b are 0°, the correlation signal 205 becomes null. When the interference phases are 180°, the correlation signal 205 becomes maximal. If the interference phases are 90° or 270°, the correlation signal 205 takes on an intermediate value.

The photocurrents flowing through the current source terminals of the two photodetectors 141 and 142 of the optical balanced receiver 140 have waveforms showing AC components as mutually logical inverses. Therefore, the photocurrent detectors detect the two photocurrents, and convert them into photocurrent signals. A difference circuit calculates the difference between the two photocurrent signals. Thus, a difference signal whose AC component has a two-fold amplitude and which has a DC component, which is shared by the two photocurrent signals, removed can be produced. If the two optical phase detectors 120 and 120b of the DQPSK optical receiver 101 detect difference signals and input them as substitutes for the photocurrent signals 181 and 181b to the correlator 200, the detection sensitivity of the correlator 200 can be upgraded.

### Second Embodiment

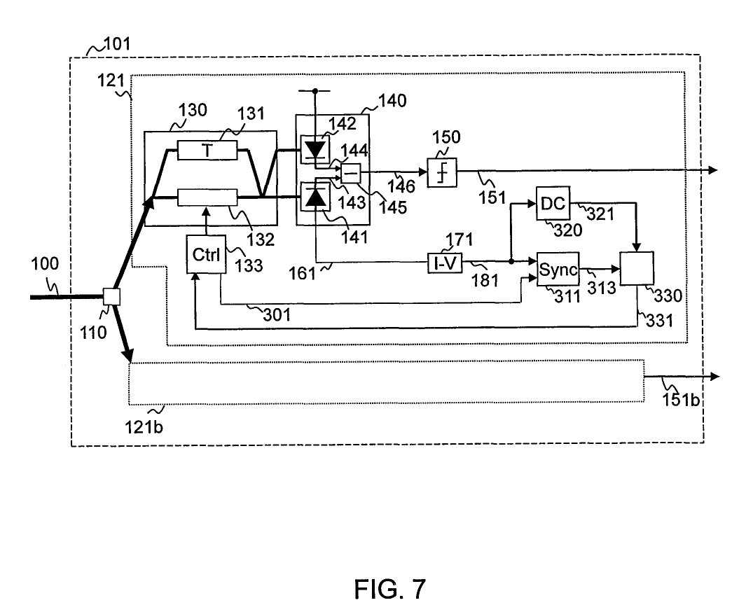

The second embodiment of the present invention utilizes a DC component of a photocurrent. FIG. 7 is a configuration diagram (1) of a DQPSK optical receiver in accordance with the second embodiment. The configuration of the receiver will be detailed later.

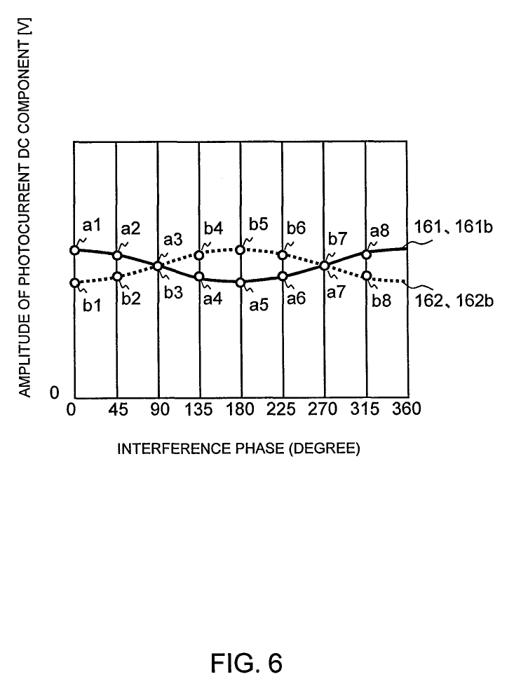

FIG. 6 shows the relationship between the interference phase of the optical delay line interferometer 130 and the DC component of a photocurrent flowing through the current source terminal 161 of the photodetector 141 that receives interfering light outputted from the optical delay line interferometer 130. The amplitude of the DC component varies like a sine wave with respect to the interference phase of the optical delay line interferometer 130. When the interference phase is 0°, the amplitude becomes maximal (a1 in FIG. 6). When the interference phase is 180°, the amplitude becomes minimal (a5 in FIG. 6). When the interference phase is 360°, the amplitude returns to be maximal. The amplitude of the DC component of a photocurrent flowing through the current source terminal 162 of the other photodetector 142 of the optical balanced receiver 140 also varies like a sine wave with respect to the interference phase. However, when the interference phase is 0°, the amplitude becomes minimal (b1 in FIG. 6). When the interference phase is 180°, the amplitude becomes maximal (b5 in FIG. 6). When the interference phase is 360°, the amplitude returns to be minimal. However, the characteristic that the DC component of a photocurrent varies, as shown in FIG. 6, depending on the interference phase of the optical delay line interferometer is manifested only when signal light to be received by the DQPSK optical receiver 101 is not RZ-modulated, or the RZ-modulated component of signal light is deteriorated by an optical filter or the optical delay line interferometer included in the DQPSK optical receiver 101.

In the second embodiment of the present invention, the amplitude of the DC component of a photocurrent flowing through the current source terminal 161 is detected. However, the interference phase cannot be uniquely identified based only on the amplitude. Therefore, the gradient of a variation in the DC component of a photocurrent with respect to the interference phase is detected in order to uniquely identify the interference phase. The interference phases of the two optical delay line interferometers 130 and 130b of the DQPSK optical receiver 101 are controlled so that the difference between them becomes 90°. The gradient of the variation in the DC component of a photocurrent with respect to the interference phase of the optical delay line interferometer can be detected by detecting an increase or decrease in the DC component of a photocurrent signal occurring when the interference phase of the optical delay line interferometer 130 is microscopically fluctuated.

For example, a description will be made of a case where the interference phase of the optical delay line interferometer 130 that has undergone 45° phase control is uniquely identified. To begin with, the amplitude of the DC component of a photocurrent flowing through the current source terminal 161 is compared with the amplitude shown in FIG. 6 (a3) (or the mean value or intermediate value of the amplitude of the DC component of a photocurrent signal that varies depending on the interference phase). If the amplitude of the DC component of the photocurrent is larger than the amplitude (a3), the interference phase is identified as 45° or 315°. If the amplitude is smaller than the amplitude (a3), the interference phase is identified as 135° or 225°. When the interference phase is slightly increased, if the amplitude of the DC component of the photocurrent decreases accordingly, the interference phase is identified as 45° or 135°. If the amplitude increases, the interference phase is identified as 225° or 315°. Therefore, once the two results of identification are used in combination, the interference phase of the optical delay line interferometer 130 can be uniquely identified. In the 45° phase control for the interference phase described in the patent document 1, the interference phase is microscopically fluctuated all the time. In the present embodiment, the microscopic fluctuation in the interference phase can be effectively utilized.

However, if it is uncertain whether the detected photocurrent is the photocurrent flowing through the current source terminal 161 or the photocurrent flowing through the current source terminal 162, the interference phase is not uniquely determined according to the foregoing method. In the above example, whether the interference phase is either of 45° and 225° or either of 135° and 315° cannot be decided. However, in the DQPSK optical receiver 101, as long as whether the difference between the interference phases of the optical delay line interferometers 130 and 130b is 90° is decided, since the interference phases to be identified may have a difference of 180°, the aforesaid method can be applied.

Even when it is uncertain whether the detected photocurrent is the photocurrent flowing through the current source terminal 161 or the photocurrent flowing through the current source terminal 162, the interference phases can be uniquely determined. However, both the photocurrents flowing through the current source terminals 161 and 162 have to be detected, and the amplitudes of the DC components of the two detected photocurrents have to be compared with each other.

For example, in the optical phase detector including the optical delay line interferometer 130 whose interference phase has undergone 45° phase control, if it is uncertain whether the detected photocurrent is the photocurrent flowing through the current source terminal 161 or the photocurrent flowing through the current source terminal 162, whether the interference phase is either of 45° and 225° or either of 135° and 315° cannot be decided. However, when the amplitudes of the DC components of the photocurrents flowing through the current source terminals 161 and 162 respectively are compared with each other, the interference phase of the optical delay line interferometer 130 can be uniquely identified. The amplitudes of the DC components of two photocurrents are compared with each other. If the photocurrent used to identify the interference phase is larger than the other, the interference phase is identified as 45° or 315°. If the photocurrent is smaller, the interference phase is identified as 135° or 225°. Therefore, when this result of identification is used in combination with the aforesaid result of identification, the interference phase can be uniquely identified.

Aside from the present embodiment, when the amplitudes of photocurrents flowing through the current source terminals of two photodetectors are compared with each other, a mechanism for compensating the difference between the amplitudes of the photocurrents derived from a difference in receiving sensitivity or a frequency band between the two photodetectors should preferably be included.

In the DQPSK optical receiver, whether the difference between the interference phases of the two optical delay line interferometers 130 and 130b is 90° can be decided based on the DC components of photocurrents flowing through the current source terminals 161 and 161b of the photodetectors 141 and 141b, which receive interfering light waves outputted from the two optical delay line interferometers 130 and 130b, and the gradients of the variations in the DC components of the two photocurrents with respect to the interference phases of the two optical delay line interferometers 130 and 130b.

For example, when the interference phases of the two optical delay line interferometers 130 and 130b of the DQPSK optical receiver 101 have undergone 45° phase control, if the amplitudes of the DC components of photocurrents flowing through the two current source terminals 161 and 161b increase or decrease in the same manner along with an increase or decrease in the interference phases (the signs of the gradients are squared with each other) and the amplitudes of the DC components of the photocurrents flowing through the two current source terminals 161 and 161b have a difference, the difference between the interference phases of the two optical delay line interferometers 130 and 130b is identified as 90° (for example, interference phases at points a2 and a4 in FIG. 6). In addition, if the gradients are different from each other and the amplitudes are squared with each other, the difference between the interference phases is identified as 90° (for example, interference phases at points a2 and a8). In contrast, if the gradients are different from each other and the amplitudes are different from each other, the difference between the interference phases of the two optical delay line interferometers 130 and 130b is not identified as 90° (for example, interference phases at points a2 and a6 in FIG. 6). If the gradients are identical to each other and the amplitudes are identical to each other, the difference between the interference phases is not identified as 90°.

FIG. 7 shows the configuration of a DQPSK optical receiver 101 in accordance with the second embodiment of the present invention.

A DQPSK optical receiver 101 includes two controlled optical phase detectors 121 and 121b. In the controlled optical phase detectors 121 and 121b, signal light inputted to an input port 100 is, similarly to that in the DQPSK optical receiver 101 shown in FIG. 1, converted into receiving data items 151 and 151b by two optical phase detectors each including an optical delay line interferometer and an optical balanced receiver. The configuration of the controlled optical phase detector 121b is identical to that of the controlled optical phase detector 121. FIG. 7 therefore does not show the details of the controlled optical phase detector 121b.

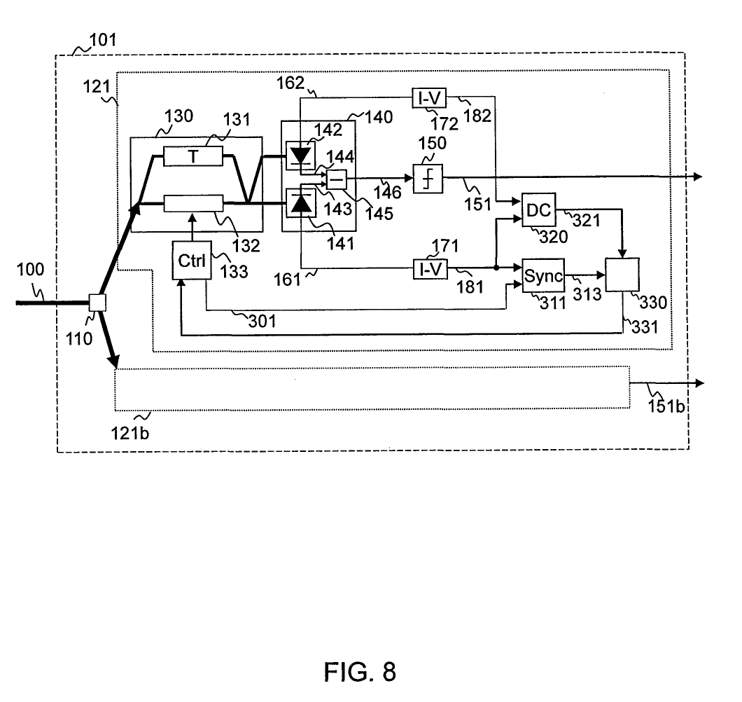

The controlled optical phase detector includes, in addition to the optical phase detector, a control circuit that controls the interference phase of the optical delay line interferometer. For example, in the control circuit of the controlled optical phase detector 121, similarly to that in FIG. 5 representing the first embodiment, a photocurrent that flows through one current source terminal 161 of the current source terminals of two photodetectors 141 and 142 of an optical balanced receiver 140 which receive two interfering light waves outputted from the optical delay line interferometer 130 is detected by a photocurrent detector 171, and outputted as a photocurrent signal 181. The interference phase of the optical delay line interferometer 130 is subjected to, for example, 45° phase control by a phase controller 133, and stabilized at an arbitrary interference phase that is not unique. The phase controller 133 microscopically fluctuates the interference phase, and outputs the microscopic fluctuation component as a dither signal 301. The dither signal 301 and photocurrent signal 181 are synchronized with each other by a synchronism detector 311. Whether the positivity or negativity of an increase or decrease in the amplitude of the photocurrent signal 181 is identical to or inverse to that of an increase in the dither signal 301 is decided in order to output a synchronizing (sync) signal (gradient information) 313. An amplitude comparator 320 compares the temporal mean value of the photocurrent signal 181 with a predetermined threshold, decides whether the temporal mean value is larger or smaller, and outputs an amplitude comparison signal 321. The threshold may be a mean amplitude of the photocurrent signal 181 that varies depending on the interference phase. The value can be obtained in advance by, for example, changing the interference phase from 0° to 360° and averaging the temporal mean values of the photocurrent signal 181. Similarly to the example (2) of the configuration shown in FIG. 8, a photocurrent detector 172 that detects a photocurrent flowing through the current source terminal 162 of the other photodetector 142 of the optical balanced receiver 140 and converts it into a photocurrent signal 182 may be further included. The amplitude of the photocurrent signal 182 or the temporal mean value thereof may be adopted as the threshold. The sync signal 313 and amplitude comparison signal 321 are inputted to a quadrature controller 330. The interference phase of the optical delay line interferometer 130 is identified based on the combination of the signals. A quadrature control signal 331 is outputted to the phase controller 133 until the interference phase becomes an arbitrary value.

The controlled optical phase detector 121b has the same configuration as the controlled optical phase detector 121. Control is implemented so that the interference phases of the optical delay line interferometers of the controlled optical phase detectors 121 and 121b respectively have a difference of 90°. For example, the optical receiver has settings determined in advance so that the interference phases of the optical delay line interferometers of the controlled optical phase detectors 121 and 121b respectively have the difference of 90°, and controls the phase controller 133 so that the interference phases can be attained.

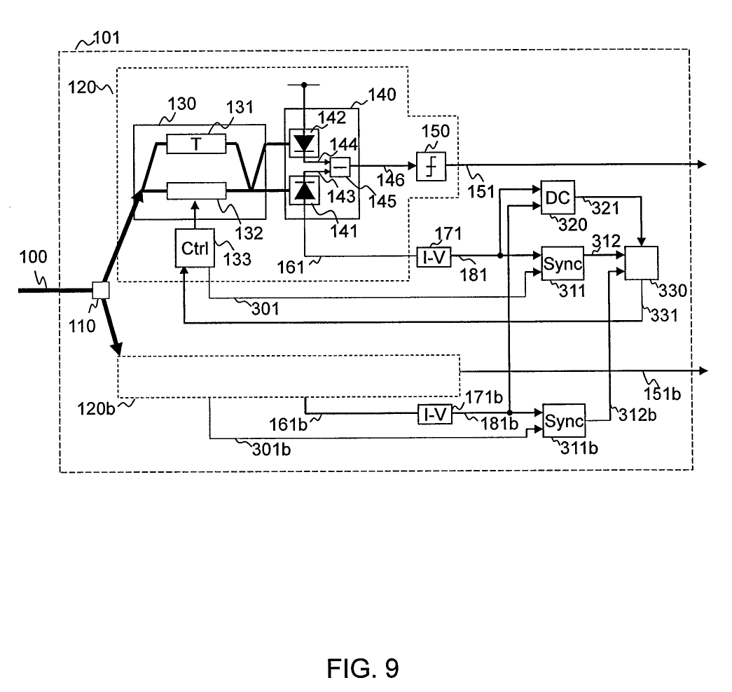

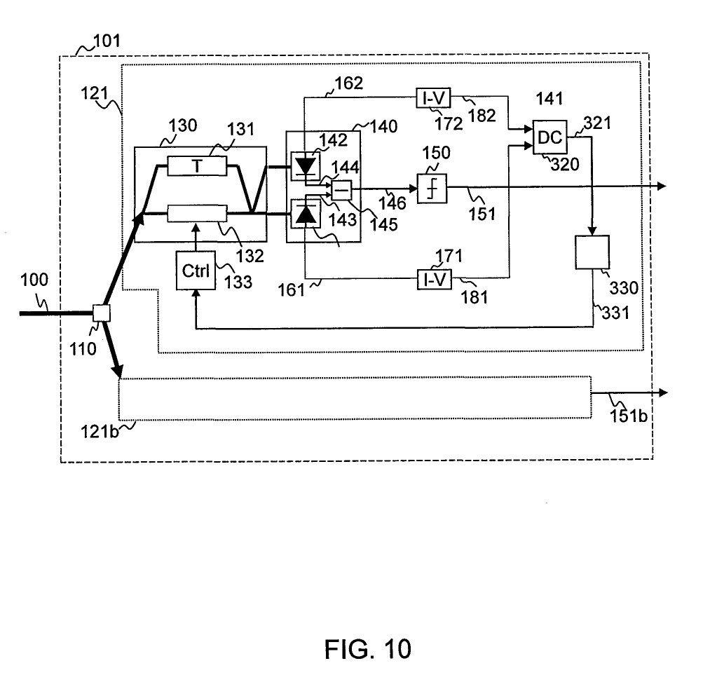

FIG. 9 shows another example (3) of the configuration of the DQPSK optical receiver 101 in accordance with the second embodiment.

Similarly to the DQPSK optical receiver 101 shown in FIG. 7, signal light inputted to an input port 100 is converted into receiving data items 151 and 151b by two optical phase detectors 120 and 120b each including an optical delay line interferometer and an optical balanced receiver. A photocurrent flowing through one of the current source terminals 161 and 162 of photodetectors 141 and 142, which receive two interfering light waves outputted from the optical delay line interferometer 130 of the optical phase detector 120, for example, the current source terminal 161 is detected as a photocurrent signal 181 by a photocurrent detector 171. Similarly, a photocurrent flowing through one of the current source terminals 161b and 162b of photodetectors 141b and 142b, which receive two interfering light waves outputted from an optical delay line interferometer 130b of the optical phase detector 120b, for example, the current source terminal 161b is detected as a photocurrent signal 181b by a photocurrent detector 171b.

The interference phases of the optical delay line interferometers 130 and 130b are subjected to, for example, 45° phase control by phase controllers 133 and 133b respectively, and stabilized at arbitrary interference phases that are not unique. Phase controllers 133 and 133b microscopically fluctuate the interference phases, and output the microscopic fluctuation components as dither signals 301 and 301b. The dither signal 301 and photocurrent signal 181 are inputted to a synchronism detector 311. Whether the direction (positivity or negativity) of an increase or decrease in the DC component of the photocurrent signal 181 is squared with that of an increase or decrease in the dither signal 301 is detected, and a sync signal 312 is outputted. Likewise, the dither signal 301b and photocurrent signal 181b are inputted to a synchronism detector 311b. Whether the direction (positivity or negativity) of an increase or decrease in the DC component of the photocurrent signal 181b is squared with that of an increase or decrease in the dither signal 301b is detected, and a sync signal 312b is outputted. An amplitude comparator 320 compares the amplitudes of the DC components of the photocurrent signals 181 and 181b with each other, decides whether the amplitude of the DC component of the photocurrent signal 181 or 181b is larger or smaller, and outputs an amplitude comparison signal 321.

The amplitude comparison signal 321 and the sync signals 313 and 313b are inputted to the quadrature controller 330. Based on the input signals, the interference phases of the two optical delay line interferometers 130 and 130b are identified. A quadrature control signal 331 is outputted to each of the phase controllers 133 and 133b until the interference phases take on arbitrary values. While the quadrature control signal 331 is being inputted to the phase controllers 133 and 133b, the phase controllers 133 and 133b shift the interference phases and control the interference phases so that the interference phases take on set values. The set values are 90° deviated from each other by the optical phase detectors 120 and 120b. Incidentally, the quadrature controller 330 may control one of the phase controllers 133 and 133b so that the difference between the interference phases becomes 90°.

### Third Embodiment

The third embodiment of the present invention also utilizes the DC component of a photocurrent. FIG. 10 is a configuration diagram of a DQPSK optical receiver in accordance with the third embodiment. The configuration of the receiver will be detailed later.

By referencing the relationship between the interference phase of the optical delay line interferometer 130 and the amplitudes of the DC components of photocurrents flowing through the current source terminals 161 and 162 of the photodetector 141, which is shown in FIG. 6, it is found that when the interference phase is 0° or 180°, the amplitudes of the DC components of the two photocurrents have a difference. In contrast, when the interference phase is 90° or 270°, the difference between the amplitudes of the DC components of the two photocurrents is null. The same applies to the controlled optical phase detector 121b.

The interference phase of the optical delay line interferometer is subjected to 90° phase control and stabilized at any of 0°, 90°, 180°, and 270°. The difference between the amplitudes of the DC components of the two photocurrents flowing through the current source terminals 161 and 162 is calculated. Whether the difference is null is decided. This reveals that the interference phase of the optical delay line interferometer is either 0° or)180° (0+n·180°, or either 90° or)270° (90+n·180°. Thereafter, the interference phase of the optical delay line interferometer is arbitrarily shifted, whereby the interference phase can be controlled to be Φ+n·180° (where Φ denotes an arbitrary value and n denotes an integer). If necessary, control may be implemented for stabilizing the interference phase at a set value.

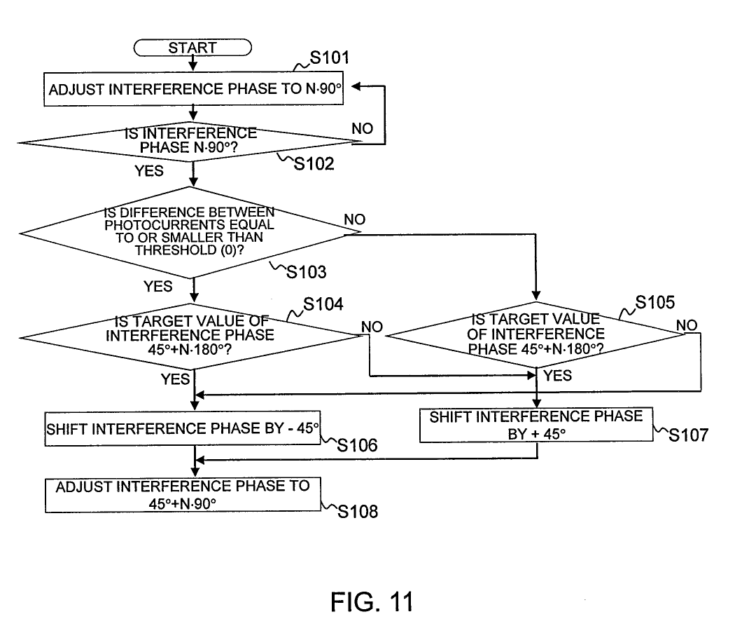

FIG. 11 shows a flowchart for an interference phase control method to be applied to a case where the interference phase of an optical delay line interferometer is controlled to be any (set value) of 45+n·180° and -45+n·180°. First, the interference phase is subjected to 90° phase control (S101 and S102). Whether the interference phase is any of 0+n·180° and 90+n·180° is decided by checking if the difference between the DC components of two photocurrents flowing through the current source terminals 161 and 162 is equal to or smaller than a predetermined threshold (S103). Based on the result of the decision and the set value of the interference phase, the interference phase is shifted so that it takes on the set value (S104 to S107). Thereafter, 45° phase control is implemented for stabilizing the interference phase at the set value (S108).

For example, assuming that a decision is made at step S103 that the difference between the two photocurrents is larger than the threshold and the interference phase is 0+n·180° (No at S103), if the set value of the interference phase, that is, a control target value is 45+n·180°, the interference phase is shifted slightly by +45° or in a +direction (S105 and S107). Thereafter, the interference phase is subjected to 45° phase control (S108), and thus stabilized at 45°. As mentioned above, the shifting direction for the interference phase is determined based on the difference between the photocurrents and the set value of the interference phase, and the interference phase is then shifted. Thereafter, the interference phase is subjected to 45° phase control.

FIG. 10 shows the configuration of the DQPSK optical receiver 101 in accordance with the third embodiment.

The DQPSK optical receiver 101 includes two controlled optical phase detectors 121 and 12b and an optical splitter 110. In the controlled optical phase detectors, signal light inputted to an input port 100 is, similarly to that in the DQPSK optical receiver 101 shown in FIG. 1, converted into receiving data items 151 and 151b by two optical phase detectors 120 and 120b each including an optical delay line interferometer and an optical balanced receiver. The configuration of the optical phase detector 120b is identical to that of the optical phase detector 120. FIG. 10 does not therefore show the details of the optical phase detector 120b.

In addition to the optical phase detector, the controlled optical phase detector includes a control circuit that controls the interference phase of an optical delay line interferometer. For example, in the control circuit of the controlled optical phase detector 121, photocurrents flowing through the current source terminals 161 and 162 of two photodetectors 141 and 142 of an optical balanced receiver 140 that receive two interfering light waves outputted from the optical delay line interferometer 130 are detected by photocurrent detectors 171 and 172 respectively, and outputted as photocurrent signals 181 and 182.

The interference phase of the optical delay line interferometer 130 is subjected to 90° phase control by a phase controller 133, and controlled to be any of 0°, 90°, 180°, and 270°.

The photocurrent signals 181 and 182 are inputted to an amplitude comparator 320, and the amplitudes of the DC components of the photocurrent signals 181 and 182 are compared with each other. An amplitude comparison signal 321 is outputted according to whether the difference between the amplitudes is null (or falls within a predetermined range around zero).

The amplitude comparison signal 321 is inputted to a quadrature controller 330. If the amplitudes of the DC components of the photocurrent signals 181 and 182 have no difference, the interference phase of the optical delay line interferometer 130 is identified as 90° or 270°. If the amplitudes have a difference, the interference phase is identified as 0° or 180°. A quadrature control signal 331 is outputted to the phase controller 133 so that the interference phase can be shifted to approach a set value.

The phase controller 133 shifts the phase according to the quadrature control signal 331, and stabilizes the phase. For example, if the set value of the interference phase is any of 45°, 135°, 225°, and 315°, 45° phase control is implemented for stabilization.

The controlled optical phase detector 121b has the same configuration as the controlled optical phase detector 121. In the DQPSK optical receiver 101, the interference phases of the optical delay line interferometers 130 and 130b in the controlled optical phase detectors 121 and 121b are designated to have a difference of 90°.

The present invention is adaptable to, for example, an optical communication system.

What is claimed is:

1. An optical receiver comprising:
two optical phase detectors each including
an optical delay line interferometer that gives a delay difference and a phase difference, which corresponds to an interference phase to be designated, to bifurcated input signal light so as to cause interference, and outputs interfering light,
a photodetector that receives the interfering light and outputs a detection signal, and
a phase controller that stabilizes the interference phase of the optical delay line interferometer at any of a plurality of predetermined values;
at least one photocurrent detector that detects photocurrents, which flow through current source terminals of the photodetectors of the two optical phase detectors respectively, and outputs photocurrent signals in accordance with the photocurrents;
a correlator that inputs the photocurrent signals of the photodetectors, which are outputted from the photocurrent detector, or signals based on the photocurrent signals, and outputs a correlation signal in accordance with a correlation between AC components of the photocurrent signals; and
a quadrature phase controller that decides based on the correlation signal whether the difference between the interference phases of the two optical delay line interferometers is 90°, and that if the difference is not 90°, outputs a control signal to one or both of the phase controllers of the two optical phase detectors,
wherein
one or both of the phase controllers of the two optical phase detectors shift the interference phases of the optical delay line interferometers according to the control signal.

2. The optical receiver according to claim 1, wherein, each optical delay line interferometer of the two optical phase detectors outputs a second interfering light that is a logical inverse of the interfering light;
each of the two optical phase detectors further includes a second photodetector that receives the second interfering light and outputs a second detection signal;
wherein the optical receiver further comprises
at least one second photocurrent detector that detects photocurrents, which flow through the current source terminals of the second photodetectors of the two optical phase detectors respectively, and outputs second photocurrent signals in accordance with the photocurrents, and
difference circuit that outputs difference signals, each of which represents the difference between the photocurrent signal and second photocurrent signal of the respective optical phase detectors, to the correlator; and
the correlator inputs the difference signals and outputs the correlation signal in accordance with the correlation between the AC components of the photocurrent signals, according to the difference signals.

3. The optical receiver according to claim 1, wherein the correlator includes:
a DC component remover that extracts the AC components of two inputted photocurrent signals; and
a circuit that correlates the AC components of the photocurrent signals, which are extracted by the DC component remover, with each other, and outputs the correlation signal.

4. The optical receiver according to claim 3, wherein:
if the correlation signal signifies that the correlation between the AC components of two photocurrent signals inputted to the correlator is smaller than a predetermined reference, the quadrature phase controller identifies the difference between the interference phases as 90°; and
if the difference between the interference phases is not 90°, the quadrature phase controller outputs the control signal for shifting the interference phases.

5. The optical receiver according to claim 1, wherein the correlator includes:
a difference circuit that calculates the difference between the two inputted photocurrent signals;
a DC component remover that removes the DC component of the difference and outputs resultant signal; and
an amplitude detector that outputs the maximum amplitude of an output signal of the DC component remover as the correlation signal.

6. The optical receiver according to claim 5, wherein,
if the correlation signal that varies depending on the interference phases takes on an intermediate value between zero and the maximum value for the variation, the quadrature phase controller identifies the difference between the interference phases as 90°; and
if the difference between the interference phases is not 90°, the quadrature phase controller outputs the control signal for shifting the interference phases.

7. An optical receiver comprising:
two optical phase detectors each including
an optical delay line interferometer that gives a delay difference and a phase difference, which corresponds to an interference phase to be designated, to bifurcated input signal lights so as to cause interference, and outputs two interfering light waves,
two photodetectors that receive the interfering light waves and output detection signals respectively, and
a phase controller that stabilizes the interference phase of the optical delay line interferometer at one of a plurality of predetermined values, microscopically fluctuates the interference phase, outputs a dither signal representing a fluctuation component, and shifts the interference phase according to an inputted control signal;
a first photocurrent detector which detects a first photocurrent, which flows through current source terminal of the photodetector of one of the two optical phase detectors, and outputs a first photocurrent signal in accordance with the first photocurrent;
a second photocurrent detector which detects a second photocurrent, which flows through current source terminal of the photodetector of the other optical phase detector, and outputs a second photocurrent signal in accordance with the second photocurrent;
an amplitude comparator which compares amplitude of the first photocurrent signal with amplitude of the second photocurrent signal, and outputs an amplitude comparison signal signifying whichever of the first and second photocurrent signals is larger;
a synchronism detector which compares an increase or decrease in the dither signal outputted from the phase controller with an increase or decrease in the first or second photocurrent signal, and outputs gradient information on the first or second photocurrent signal; and
a quadrature phase controller which identifies the interference phase of the optical delay line interferometer on the basis of the gradient information and the amplitude comparison signal, and outputs a control signal to the phase controller so that the interference phase takes on a desired value.

8. An optical receiver comprising:
two optical phase detectors each including
an optical delay line interferometer that gives a delay difference and a phase difference, which corresponds to an interference phase to be designated, to bifurcated input signal light so as to cause interference, and outputs two interfering light waves whose intensity components are logically inverted each other,
two photodetectors that receive individual two interfering light waves, and
a phase controller that controls the interference phase of the optical delay line interferometer so that the interference phase becomes any of 0°, 90°, 180°, and 270°;
at least one photocurrent detector that detects photocurrents, which flow through current source terminals of the two photodetectors included in at least either of the two optical phase detectors, and outputs photocurrent signals in accordance with the photocurrents,
an amplitude comparator that compares DC components of the photocurrent signals with each other, and outputs an amplitude comparison signal in accordance with the difference between the DC components; and
a quadrature phase controller that identifies value of the interference phase of the optical delay line interferometer according to whether the amplitude comparison signal is null or equal to or smaller than a predetermined threshold, and outputs a control signal so as to set the difference between the interference phases to 90°, to the phase controller according to a result of identification.

9. The optical receiver according to claim 8, comprises the photocurrent detector, the amplitude comparator, and the quadrature phase controller for each of the optical phase detectors.

10. The optical receiver according to claim 8, wherein after the quadrature phase controller decides based on the amplitude comparison signal whether the interference phase of the optical delay line interferometer is either of 0° and 180° or either of 90° and 270°, the quadrature phase controller determines the direction of an increase or decrease in the interference phase according to the result of the decision and a set value predetermined so that the difference between the interference phases becomes 90°, and shifts the interference phase in the direction.

11. The optical receiver according to claim 10, wherein,
the quadrature phase controller outputs the control signal which causes the interference phase to shift 45° in the direction determined; and
the phase controller shifts the interference phase 45° according to the control signal to thereby control the interference phase so that the interference phase becomes any of the set values predetermined that are 45°, 135°, 225°, and 315°.
